(19) United States
(12) Patent Application Publication
(10) Pub. No.: US 2026/0251789 A1
(43) Pub. Date: Aug. 27, 2026

(54) METHOD FOR GENERATING LIGHT SOURCE IN DETECTION MODULE AND DETECTION MODULE

(71) Applicant: LITE-ON OPTO TECHNOLOGY (CHANGZHOU) CO., LTD., CHANGZHOU CITY (CN)

(72) Inventors: Yi-xuan Zou, CHANGZHOU CITY (CN); Shu-yong Jia, Changzhou City (CN)

(21) Appl. No.: 19/550,221

(22) Filed: Feb. 25, 2026

(30) Foreign Application Priority Data
Feb. 27, 2025 (CN) 202510229264.2

(51) Int. Cl. G01S 17/00; G01J 3/28; G01S 7/481; G01S 7/497; G01S 17/89

(52) U.S. Cl. CPC G01S 17/006; G01J 3/28; G01S 7/4815; G01S 7/497; G01S 17/89; G01J 2003/284; G01J 2003/2866

(57) ABSTRACT

A method for generating a light source in a detection module and a detection module. The method includes: obtaining a sensor having a sensing spectral curve in a predetermined wavelength range; and arranging a light source to generate a predetermined light having an emitting spectral curve in the predetermined wavelength range. After the sensing spectral curve and the emitting spectral curve are overlapped with each other, a matching curve is generated and a standard deviation of the matching curve is less than 0.1. The matching curve generated after the sensing spectral curve and the emitting spectral curve are overlapped is expressed by the following equation: Z(λ)=W(λ)·S(π), where λ is a wavelength, S(π) is the sensing spectral curve, W(λ) is the emitting spectral curve, and Z(λ) is the matching curve.

### CROSS-REFERENCE TO RELATED PATENT APPLICATION

This application claims the benefit of priority to China Patent Application No. 202510229264.2, filed on Feb. 27, 2025, in the People's Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a device and a method, and more particularly to a light source, a detection module, and a method for generating the light source in the detection module.

### BACKGROUND OF THE DISCLOSURE

A machine vision system is mainly composed of modules such as an optical system (including a light source, a lens, and an industrial camera), an image acquisition unit, an image processing unit, an actuator, and a human-machine interface. Compared to human vision, machine vision exhibits significant advantages in various aspects, including higher efficiency, faster speed, and a more stable detection performance. However, the initial investment cost of a machine vision system is high. Although it may be more cost-effective in the long run, it comes with higher requirements for capital and technology.

In a machine vision system, an industrial camera and a sensor are key components responsible for capturing high-quality images, while the design of a light source directly affects the quality of input data and the overall application performance. During operation, a photoelectric sensor needs to control the energy of the input light signal and can only function properly within the range from a minimum detectable optical power to a saturated optical power. Once the optical power exceeds the saturation value, the sensor may not only be unable to output an accurate signal amplitude, but may also cause damage to the device, affecting the stability and service life of the detection system. Therefore, during system design, it is necessary to precisely control the input of the optical signal to ensure that the sensor can operate normally and maintain detection accuracy.

Furthermore, to enable the sensor to achieve its maximum performance, the spectral matching of the light source and the photoelectric sensor is crucial. If the spectral characteristics of the light source do not match the sensor, the signal reception efficiency and detection accuracy of the system will be affected, which may lead to recognition errors or a decrease in sensitivity. Most of the current machine vision systems use halogen lamps or LED light source modules with an emission curve that matches that of a halogen lamp. However, as the spectral ranges to be detected by machine vision are increasing, the existing light sources still have room for optimization in terms of full-range matching, sensor adaptability, and cost control, and are in need of further improvement to meet application demands in complex environments requiring higher precision.

### SUMMARY OF THE DISCLOSURE

In response to the above-referenced technical inadequacies, the present disclosure provides a light source, a detection module, and a method for generating the light source in the detection module to address the deficiencies of the relevant art, the light source is capable of properly matching the sensing spectral curve of a sensor, and is beneficial for reducing the difficulty of adjusting a detector.

In order to solve the above-mentioned problems, one of the technical aspects adopted by the present disclosure is to provide a light source. The light source includes at least one light-emitting unit. The light source is configured to generate a predetermined light. The predetermined light has an emitting spectral curve within a first wavelength range. The emitting spectral curve has a regression curve after being subjected to a third-order polynomial regression. The regression curve has a minimum value within a second wavelength range. The first wavelength range is from 400 nm to 1000 nm, the second wavelength range is from 540 nm to 560 nm, and a coefficient of determination of the regression curve is greater than or equal to 0.85.

In order to solve the above-mentioned problems, another one of the technical aspects adopted by the present disclosure is to provide a method for generating a light source in a detection module. The method includes: obtaining a sensor having a sensing spectral curve in a predetermined wavelength range; and arranging a light source to generate a predetermined light having an emitting spectral curve in the predetermined wavelength range. After the sensing spectral curve and the emitting spectral curve are overlapped with each other, a matching curve is generated and a standard deviation of the matching curve is less than 0.1. The matching curve generated after the sensing spectral curve and the emitting spectral curve are overlapped is expressed by the following equation: Z(λ)=W(λ)·S(λ). λ is a wavelength, S(λ) is the sensing spectral curve, W(λ) is the emitting spectral curve, and Z(λ) is the matching curve.

In order to solve the above-mentioned problems, yet another one of the technical aspects adopted by the present disclosure is to provide a detection module. The detection module includes a sensor and a light source. The sensor has a sensing spectral curve within a predetermined wavelength range. The light source generates a predetermined light. The predetermined light has an emitting spectral curve within the predetermined wavelength range.

After the sensing spectral curve and the emitting spectral curve are overlapped with each other, a matching curve is generated and a standard deviation of the matching curve is less than 0.1. The matching curve generated after the sensing spectral curve and the emitting spectral curve are overlapped is expressed by the following equation: Z(λ)=W(λ)·S(λ). λ is a wavelength, S(λ) is the sensing spectral curve, W(λ) is the emitting spectral curve, and Z(λ) is the matching curve.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for generating a light source in a detection module according to an embodiment of the present disclosure;

FIG. 2 is a detailed flowchart of step S11 of FIG. 1;

FIG. 3A to FIG. 3D are graphs of a plurality of sensing spectral curves of four different sensors and corresponding first regression curves according to the embodiment of the present disclosure;

FIG. 4A to FIG. 4D are graphs of a plurality of emitting spectral curves of light sources corresponding to the four different sensors of FIG. 3A to FIG. 3D and corresponding second regression curves, and the light sources are generated by the method according to the embodiment of the present disclosure;

FIG. 5 is a block diagram of the detection module according to another embodiment of the present disclosure;

FIG. 6 is a block diagram of one of the light sources according to yet another embodiment of the present disclosure;

FIG. 7 is a schematic diagram of a basic structure of a light-emitting unit according to the embodiment of the present disclosure;

FIG. 8 is a graph of one of the emitting spectral curves of one of the light sources according to the embodiment of the present disclosure;

FIG. 9 is a top view of an arrangement of the light-emitting unit of one of the light sources according to the embodiment of the present disclosure;

FIG. 10 is a graph having one of the emitting spectral curves and a linear regression curve thereof of one of the light sources according to the embodiment of the present disclosure and emitting spectral curves of two other types of halogen lamps;

FIG. 11 is a graph of the sensing spectral curves of three exemplary sensors according to the embodiment of the present disclosure; and

FIG. 12 is a graph of matching curves generated by superposing the emitting spectral curves of FIG. 10 and the sensing spectral curves of FIG. 11.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure provides a light source, a detection module, and a method for generating a light source in the detection module. An emitting spectral curve of the light source has a uniform and good matching with a sensing spectral curve of the sensor at all wavelengths, which facilitates the adjustment of the detection module in practice.

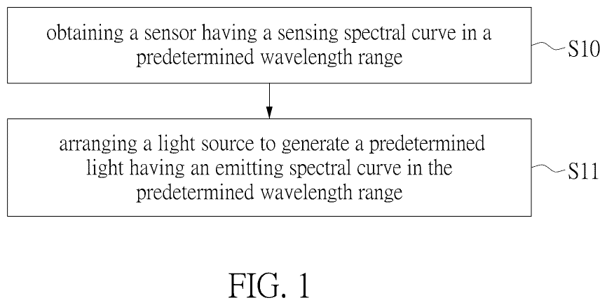

FIG. 1 is a flowchart of a method according to an embodiment of the present disclosure. Referring to FIG. 1, an embodiment of the present disclosure provides a method of generating the light source in a detection module. The method includes:

Step S10: obtaining a sensor having a sensing spectral curve in a predetermined wavelength range. The sensing spectral curve reflects the response of the sensor to light signals at different wavelengths.

Step S11: arranging a light source to generate a predetermined light having an emitting spectral curve in the predetermined wavelength range.

In arranging the light source, it is necessary to consider superimposing the emitting spectral curve W(λ) and the sensing spectral curve S(λ) to calculate the matching curve Z(λ), the mathematical relationship of which is as follows:

$$Z ( λ ) = W ( λ ) \cdot S ( λ ) .$$

The matching curve Z(λ) reflects a spectral coupling effect between the light source and the sensor over the entire wavelength range. To ensure that the matching degree reaches an optimal level, a standard deviation of the matching curve is required to be less than 0.1. The setting of the standard deviation value ensures the stability of the spectral matching, so that the emitting spectrum of the light source is highly consistent with the sensing characteristics of the sensor over the entire working wavelength range, thereby maximizing the accuracy and efficiency of optical detection.

Subsequently, the configuration of the light source is completed when the standard deviation of the matching curve is less than 0.1. If the standard deviation is equal to or greater than 0.1, a composition and a power ratio of a plurality of light-emitting units of the light source are adjusted until the standard deviation is less than 0.1.

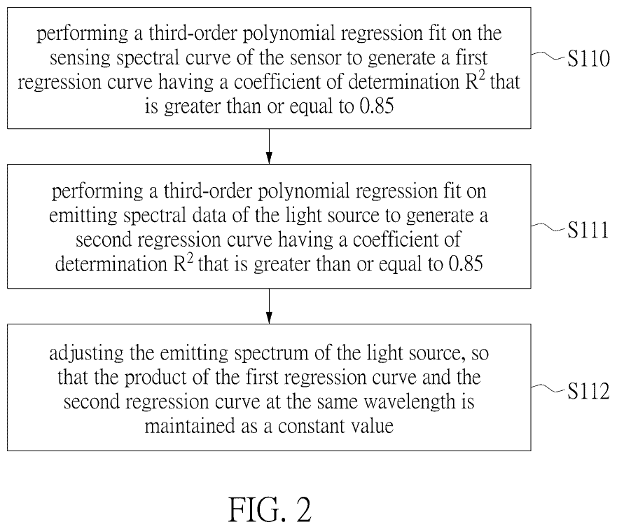

In an embodiment of Step S11, a method for fitting the emitting spectral curve is exemplified as follows. Referring to FIG. 2, FIG. 2 is a detailed flowchart of step S11 of FIG. 1. As shown in FIG. 2, in order for the light source to have an appropriate emitting spectral curve within the wavelength range matched with the sensor, Step S11 further includes the following steps:

Step S110: performing a third-order polynomial regression fit on the sensing spectral curve of the sensor to generate a first regression curve (X) having a coefficient of determination R² that is greater than or equal to 0.85. In this step, a value of the coefficient of determination R² is generally a value within a range from 0 to 1, and the closer the value of the coefficient of determination R² is to 1, the better the fit. Accordingly, in order to ensure that the regression curve can sufficiently fit the original sensing spectral curve, the coefficient of determination R² of the first regression curve (X) is required to be greater than or equal to 0.85.

Step S111: performing a third-order polynomial regression fit on emitting spectral data of the light source to generate a second regression curve (Y) having a coefficient of determination R² that is greater than or equal to 0.85. In order to ensure the quality of the fit, the coefficient of determination R² of the second regression curve is required to be greater than or equal to 0.85.

To optimize the overall spectral matching characteristics of the detection module and ensure that the light source can provide a light signal most suitable for detection by the sensor, Step S112 is further performed: adjusting the emitting spectrum of the light source, so that the product of the first regression curve and the second regression curve at the same wavelength is maintained as a constant value. For example, it can be expressed by the following formula: Y*X=k, where X is the first regression curve, Y is the second regression curve, and k is a constant, for example, 1, 0.5, or 0.1.

Under this premise, the emitting spectral curve of the light source and the sensing spectral curve of the sensor can form a complementary relationship within a specific wavelength range (in terms of profile, similar to forming an upside-down relationship), so as to optimize the effect of signal transmission and reception and reduce unnecessary spectral loss or interference. By means of this optimization process, the spectral matching degree of the detection module can be improved, ensuring that the sensor has an optimal response capability within the target wavelength range, thereby improving the detection accuracy and stability of the system.

In the present embodiment, the execution order of Step S110 and Step S112 is not limited.

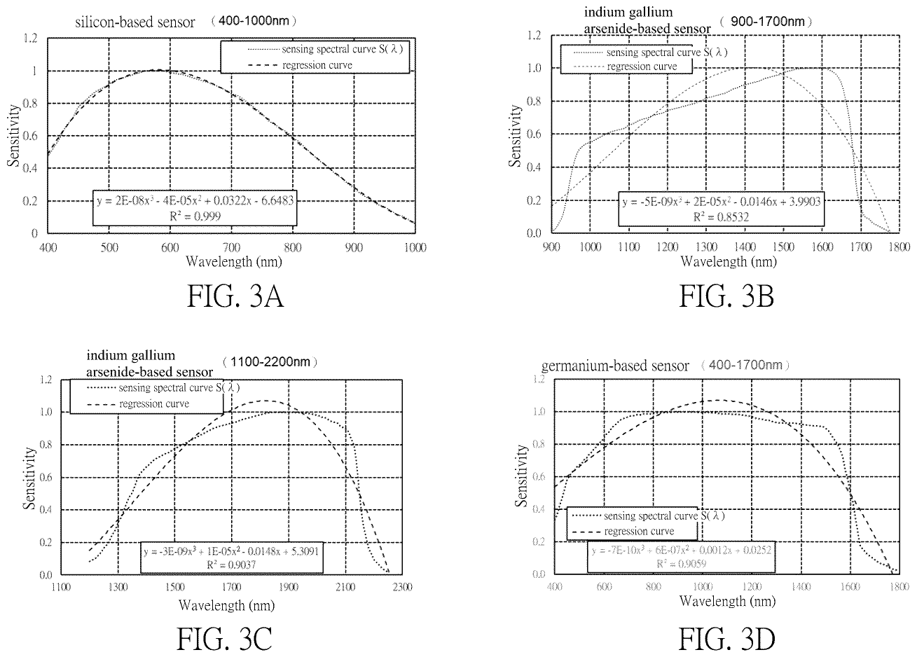

Referring to FIG. 3A to FIG. 3D, FIG. 3A to FIG. 3D are graphs of a plurality of sensing spectral curves of four different sensors and corresponding first regression curves according to the embodiment of the present disclosure. The sensors of FIG. 3A to FIG. 3D include a silicon-based sensor (top left), an indium gallium arsenide-based sensor (top right and bottom left), and a germanium-based sensor (bottom right). The sensitivity range of the silicon-based sensor is within a range from 400 nm to 1000 nm, the sensitivity range of the indium gallium arsenide-based sensor is within in a range from 900 nm to 1700 nm and a range from 1100 nm to 2200 nm, and the sensitivity range of the germanium-based sensor is within a range from 400 nm to 1800 nm. Furthermore, the cubic regression polynomial used by the first regression curve (X) is X(λ)=aλ3+bλ2+cλ+d, and a fitted result is as shown in FIG. 3A to FIG. 3D.

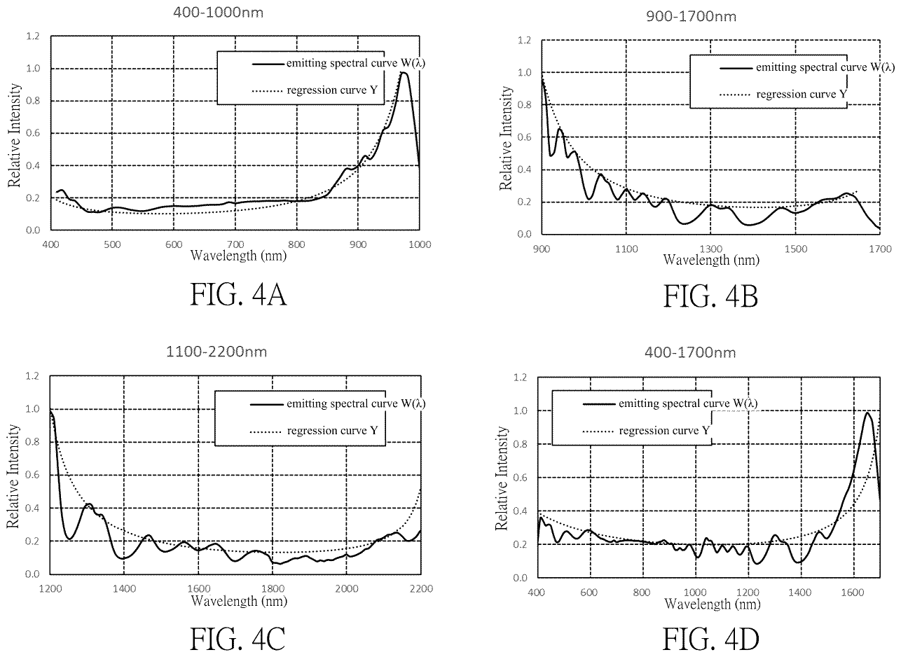

Referring to FIG. 4A to FIG. 4D, FIG. 4A to FIG. 4D are graphs of a plurality of emitting spectral curves of light sources corresponding to the four different sensors of FIG. 3A to FIG. 3D and corresponding second regression curves. The light sources are generated by the method according to the embodiment of the present disclosure.

As shown in FIG. 4A to FIG. 4D, the emitting spectral curves of FIG. 4A to FIG. 4D respectively correspond to the silicon-based sensor (top left), the indium gallium arsenide-based sensor (top right and bottom left), and the germanium-based sensor (bottom right). It can be seen from the morphology that the obtained emitting spectral curves all exhibit a complementary characteristic relative to the emitting spectral curves of FIG. 4A to FIG. 4D. For example, the portion with a higher sensitivity in the sensing spectral curve corresponds to the portion with a lower intensity in the emitting spectral curve. Furthermore, the calculated standard deviation of the matching degrees of the matching curves of four different light sources corresponding to the sensors is as shown in Table 2, all of which are less than 0.1. The smaller the standard deviation, the more uniform the matching degree between the light source and the sensor, meaning that the sensor's output signal can be more uniform and is more beneficial for subsequent data acquisition and processing.

TABLE 2

| | | indium | indium | |
|---|---|---|---|---|
| | | gallium | gallium | |
| | silicon-based | arsenide- | arsenide- | germanium- |
| | sensor | based sensor | based sensor | based sensor |
| | (400-1000 | (900-1700 | (1100-2200 | (400-1700 |
| Sensor | nm) | nm) | nm) | nm) |
| Matching | 0.025 | 0.074 | 0.043 | 0.042 |
| degree | | | | |
| standard | | | | |
| deviation | | | | |

As one of the methods for configuring the light source, a configuration method for the light-emitting units can be determined based on the emitting spectral curve of a desired predetermined light. The light-emitting units are sorted according to their corresponding wavelength widths to generate a power determination order, and starting from the light-emitting unit with a widest wavelength width, the power proportion of each light-emitting unit is determined.

For example, the type of each of the light-emitting units to be used can first be roughly determined based on the emitting spectral curve. For instance, it can be determined based on the emitting spectral curve to use at least one broadband visible light-emitting units, at least one narrowband visible light-emitting units, at least one broadband infrared light-emitting unit, and at least one narrowband infrared light-emitting units.

In the present disclosure, a visible light-emitting unit refers to a unit whose emitted light has at least 50% of its power distributed in the visible light range, and the remaining portion of the light can be in the ultraviolet light or infrared light ranges. Similarly, an infrared light-emitting unit refers to a unit whose emitted light has at least 50% of its power distributed in the infrared light range, and the remaining portion of the light can be in the visible light or ultraviolet light ranges.

In the present disclosure, a broadband light-emitting unit refers to a light-emitting unit that emits light with the majority of its power distributed in a wideband wave having a full width at half maximum (i.e., FWHM) of 200 nm or greater, whereas a narrowband light-emitting unit refers to a light-emitting unit that emits light with the majority of its power distributed in a narrowband wave having a full width at half maximum (i.e., FWHM) of 50 nm or less. More specifically, the wideband wave can be composed of a single wave or formed by superimposing multiple waves.

Subsequently, after sorting the wavelength widths, starting from one of the light-emitting units with a widest wavelength width, the power proportion of each of the light-emitting units is determined. For example, the power ratio between the at least one broadband visible light-emitting unit and the at least one broadband infrared light-emitting unit is first determined, and then the power of the at least one narrowband visible light-emitting unit and the power of the at least one narrowband infrared light-emitting unit are determined.

When the plurality of light-emitting units of the same type is provided, all powers of the plurality of light-emitting units of the same type are summed to obtain a total power, and a power proportion of all of the light-emitting units is determined according to each total power.

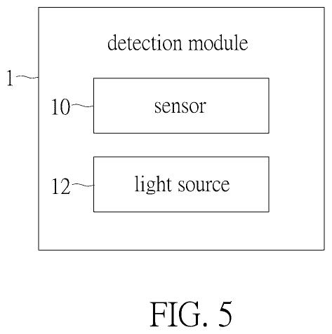

Referring to FIG. 5, FIG. 5 is a block diagram of the detection module according to another one of embodiment of the present disclosure.

As shown in FIG. 5, the detection module 1 may include a sensor 10 and a light source 12. The light source 12 is generated by a method for generating the light source in the detection module, as provided in another embodiment of the present disclosure. When the light source 12 generates a preset light, the sensor 10 can be used to receive the preset light reflected by an object.

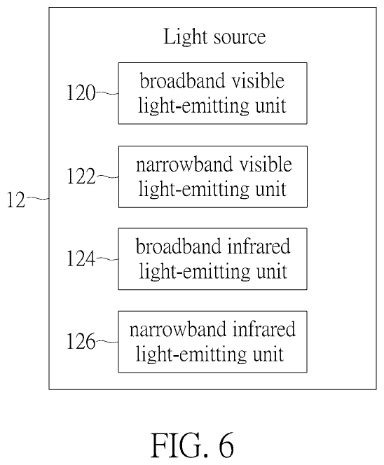

FIG. 6 is a block diagram of one of the light sources according to the embodiment of the present disclosure. In the present embodiment, the light source 12 includes at least one light-emitting unit, and the at least one light-emitting unit 120 is used to generate a predetermined light. The predetermined light exhibits a unique emitting spectral curve within a specific wavelength range and is particularly matched to the sensing spectral curve of a specific sensor.

Referring to FIG. 6, the light source 12 may, for example, include at least one broadband visible light-emitting unit 120, at least one narrowband visible light-emitting unit 122, at least one broadband infrared light-emitting unit 124, and at least one narrowband infrared light-emitting unit 126.

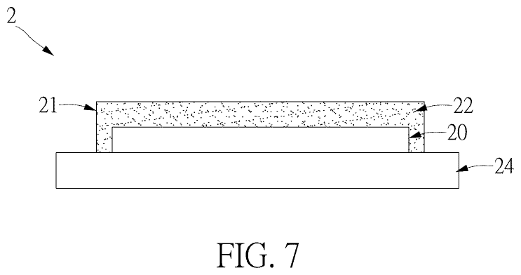

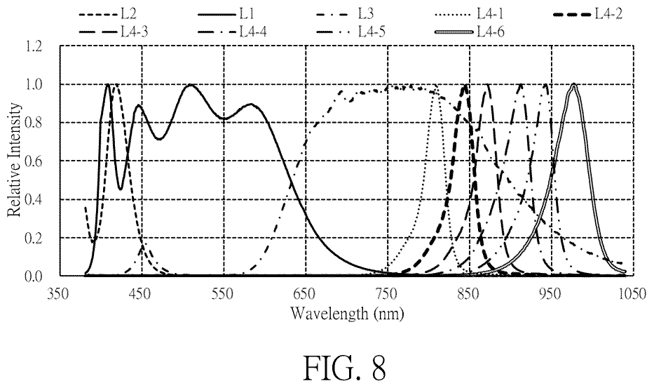

FIG. 7 is a schematic diagram of a basic structure of a light-emitting unit according to the embodiment of the present disclosure. FIG. 8 is a graph of one of the emitting spectral curves of one of the light sources according to the embodiment of the present disclosure. As shown in FIG. 7, the light-emitting unit 2 exemplarily includes a light-emitting chip 20 and an encapsulant 21, and the light-emitting chip 20 is covered by the encapsulant 21. In some embodiments, the encapsulant 21 may include a wavelength converting material 22 to achieve light output of a different wavelength. The light-emitting chip 20 typically uses a light-emitting diode (i.e., LED) as an excitation light source, and the wavelength converting material 22 may be selected from phosphors or quantum dots, which are used to absorb the original light emitted by the light-emitting chip 20 and convert it to produce light of another wavelength.

The light-emitting unit 2 further exemplarily includes a carrier 24, the light-emitting chip 20 is disposed on the carrier 24, and the light-emitting chip 20 is covered by an encapsulant 21. In an instance where the encapsulant 21 includes a wavelength converting material 22, the encapsulant 21 is exemplarily a gel coating mixed with phosphors, which can convert light emitted by the light-emitting chip 20 (e.g., short-wave blue light or ultraviolet light) into visible light or infrared light. The phosphors may be uniformly dispersed or settled in a transparent gel to achieve the designed light exit angle and color uniformity. The relative relationship between the light-emitting chip 20 and the wavelength converting material 22 determines the emitting spectral curve of the light-emitting unit 2, and all of the light-emitting units 2 collectively determine the final emitting spectral curve of the light source 12.

Based on the light-emitting unit of FIG. 7, a broadband visible light-emitting unit 120 may exemplarily include a first light-emitting chip and a first wavelength converting material, and can generate a spectral curve L1 as shown in FIG. 8. The peak wavelength of the first light-emitting chip is exemplarily within a range from 390 nm to 420 nm, and is capable of exciting the first wavelength converting material, which exemplarily includes four types of phosphors. The peak wavelength of the first phosphor is exemplarily within a range from 440 nm to 460 nm, the peak wavelength of the second phosphor is exemplarily within a range from 455 nm to 485 nm, the peak wavelength of the third phosphor is exemplarily within a range from 530 nm to 570 nm, and the peak wavelength of the fourth phosphor is exemplarily within a range from 590 nm to 610 nm. In a preferred embodiment, the peak wavelength of the first light-emitting chip used by the broadband visible light-emitting unit 120 may, for example, be 405 nm, and the peak wavelengths and corresponding phosphor materials generated by the excitation of the first light-emitting chip are as follows: 450 nm (composition: phosphate (Sr, Ca, Ba)₁₀(PO₄)₆Cl₂: Eu), 470 nm (composition: phosphate (Sr, Ca, Ba)₁₀(PO₄)₆Cl₂: Eu), 550 nm (composition: Y₃Al₅O₁₂: Ce), and 605 nm (composition: nitride (Ca, Sr) SiAlN₃: Eu). Accordingly, as shown in FIG. 8, the spectral curve L1 has a wideband wave formed by superimposing four waves within a wavelength range from 380 nm to 800 nm, and the full width at half maximum of the wideband wave is 240 nm.

Based on the light-emitting unit of FIG. 7, a narrowband visible light-emitting unit 122 may exemplarily include a second light-emitting chip and a second wavelength converting material, and generates an emitting spectral curve L2 as shown in FIG. 8. The peak wavelength of the second light-emitting chip is exemplarily within a range from 345 nm to 385 nm, and is capable of exciting the second wavelength converting material, which exemplarily includes one type of phosphor. The peak wavelength of the light produced by the excitation of the phosphor is exemplarily within a range from 400 nm to 500 nm, thereby providing a relatively narrow range of visible light output.

In a preferred embodiment, the peak wavelength of the second light-emitting chip used by the narrowband visible light-emitting unit 122 may, for example, be 365 nm, and the peak wavelength and corresponding phosphor material generated by the excitation of the second light-emitting chip is 420 nm (composition: phosphate (Sr, Ca, Ba)₁₀(PO₄)₆Cl₂: Eu). Accordingly, as shown in FIG. 3A to FIG. 3D, the spectral curve L2 has a narrowband wave within a wavelength range from 380 nm to 500 nm, and the full width at half maximum of the narrowband wave is 32 nm.

Furthermore, the broadband infrared light-emitting unit 124 can generate an infrared light spectral curve within a range from 400 nm to 800 nm. In addition, the broadband infrared light-emitting unit 124 also has a first near-infrared light spectral curve, which exhibits a bell-shaped distribution within a range from 550 nm to 1000 nm.

The broadband infrared light-emitting unit 124 exemplarily includes a third light-emitting chip and a plurality of third wavelength converting materials for generating an emitting spectral curve L3. The peak wavelength of the third light-emitting chip is exemplarily within a range from 440 nm to 470 nm and is capable of exciting three different types of phosphors. The peak wavelength generated by the excitation of the first phosphor is exemplarily within a range from 650 nm to 690 nm, the peak wavelength generated by the excitation of the second phosphor is exemplarily within a range from 700 nm to 745 nm, and the peak wavelength generated by the excitation of the third phosphor is exemplarily within a range from 800 nm to 835 nm.

In a preferred embodiment, the peak wavelength of the third light-emitting chip used by the broadband infrared light-emitting unit 124 may, for example, be 450 nm, and the peak wavelengths and corresponding phosphor materials generated by the excitation of the third light-emitting chip are as follows: 670 nm (composition: nitride (Ca, Sr) SiAlN₃: Eu), 720 nm (composition: aluminate), and 820 nm (composition: gallate). Accordingly, as shown in FIG. 8, the emitting spectral curve L3 has a broadband peak within a wavelength range from 550 nm to 1040 nm, and a full width at half maximum (FWHM) of the broadband peak is 260 nm.

Furthermore, the light source 12 exemplarily includes a plurality of narrowband infrared light-emitting units 126. Each of the narrowband infrared light-emitting units 126 exemplarily does not use a wavelength converting material, and the peak wavelength of the light-emitting chip is exemplarily within a range from 800 nm to 1000 nm. In a preferred embodiment, the narrowband infrared light-emitting units 126 exemplarily have a light-emitting chip with peak wavelengths of 810 nm, 845 nm, 870 nm, 910 nm, 940 nm, and 980 nm. Accordingly, as shown in FIG. 8, the spectral curves L4-1 to L4-6 are six narrowband waves, and the full width at half maximum of the six narrowband waves are respectively 27 nm, 30 nm, 30 nm, 38 nm, 34 nm, and 49 nm.

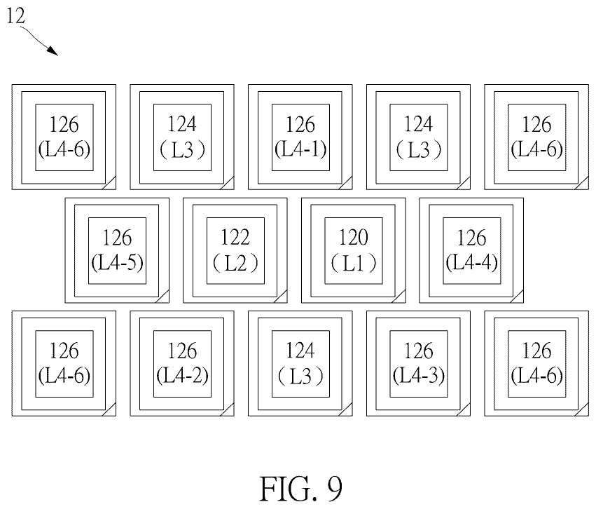

Referring to FIG. 9, FIG. 9 is a top view of an arrangement of the light-emitting unit of one of the light sources according to the embodiment of the present disclosure. The light source 12 generated by the method for generating the light source in the detection module (as shown in FIG. 1) as provided in an embodiment of the present disclosure may, for example, have a light-emitting unit configuration as shown in the top view of FIG. 9. As shown in FIG. 9, the light source 12 exemplarily includes a broadband visible light-emitting unit 120, a narrowband visible light-emitting unit 122, three broadband infrared light-emitting units 124, and nine narrowband infrared light-emitting units 126, with the arrangement as shown in FIG. 9. Furthermore, among the nine narrowband infrared light-emitting units 126, five of the nine narrowband infrared light-emitting units 126 respectively generate emitting spectral curves L4-1 to L4-5, and another four of the nine narrowband infrared light-emitting units 126 are all used to generate emitting spectral curve L4-6.

On the other hand, in accordance with the above-mentioned method, the light-emitting unit configuration adopted in the light source 12 can be determined to include a broadband visible light-emitting unit 120, a narrowband visible light-emitting unit 122, three broadband infrared light-emitting units 124, five narrowband infrared light-emitting units 126, and four narrowband infrared light-emitting units 126. The broadband visible light-emitting unit 120 has a power proportion of 19.6%. The narrowband visible light-emitting unit 122 has a power proportion of 3.7%. The three broadband infrared light-emitting units 124 have a total power proportion of 36%. The five narrowband infrared light-emitting units 126 generate emitting spectral curves L4-1 to L4-5, and the power proportions of which are respectively 8.4%, 1.5%, 2.9%, 2.9%, and 5.8%. The four narrowband infrared light-emitting units 126 generate emitting spectral curve L4-6, and have a total power proportion of 19.2%.

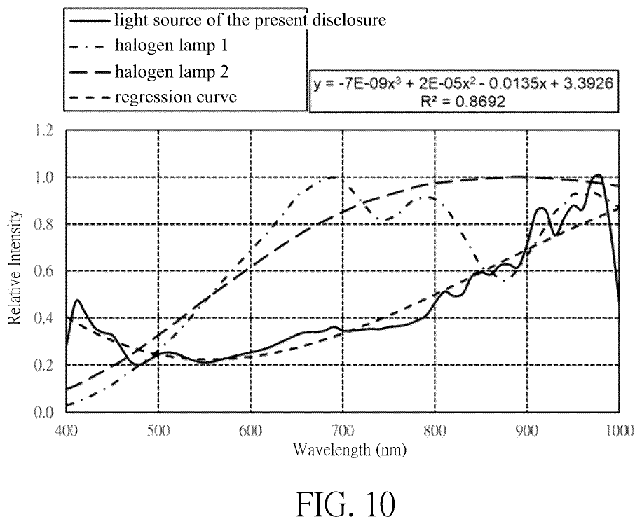

Furthermore, the waveforms and wavelength ranges of the above-mentioned light-emitting units are respectively as shown in FIG. 8, and the final emitting spectral curve is as shown in FIG. 10. FIG. 10 is a graph having one of the emitting spectral curves and a linear regression curve thereof of one of the light sources according to the embodiment of the present disclosure and emitting spectral curves of two other types of halogen lamps. In the emitting spectral curve of FIG. 10, the intensity curve of the light source from the light source exhibits minor fluctuations within a range from 400 nm to 500 nm (i.e., blue to green light regions), reaches a local peak at 410 nm, and then declines to a lowest valley value near 480 nm. Subsequently, the intensity gradually rises within a range from 500 nm to 600 nm (i.e., green to red light regions), and forms local fluctuations at 510 nm and 550 nm, with a steady increase to over 600 nm.

On the other hand, within a range from 600 nm to 800 nm (i.e., red to near-infrared regions), the intensity of the light source from the light source exhibits a gradual rising trend, with a plurality of local peaks appearing at a plurality of wavelength points, such as 690 nm, 730 nm, 810 nm, 850 nm, and 880 nm. After entering the range from 800 nm to 1000 nm (i.e., infrared range), the intensity rapidly increases, reaching higher local peaks at 920 nm and 950 nm, and finally reaching the overall maximum value at 980 nm. However, the intensity begins to sharply decrease after 990 nm.

Furthermore, the emitting spectral curve of the light source has a regression curve as shown in FIG. 10 after a third-order polynomial linear regression, which can be expressed by the following formula:

$$y = - 7 E - 09 x 3 + 2 E - 05 x 2 - 0.0135 x + 3.3926 .$$

The coefficient of determination R² of the regression curve is not less than 0.85, and the regression curve has a minimum value within a range from 540 nm to 560 nm. In the present embodiment, the coefficient of determination R² is 0.8692.

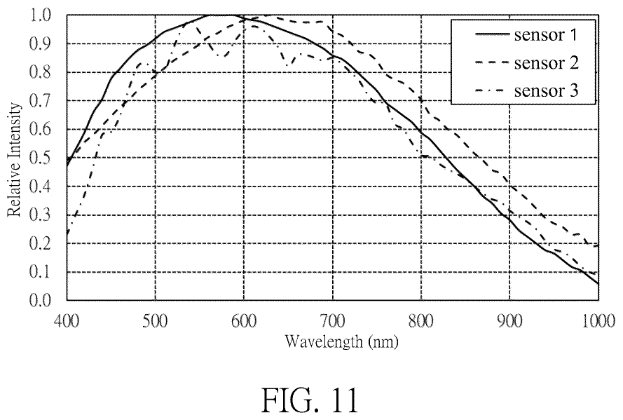

FIG. 11 is a graph of the sensing spectral curves of three exemplary sensors according to the embodiment of the present disclosure. In FIG. 11, the sensing spectral curve is the wavelength sensitivity of the sensor, which refers to the response degree of the sensor to light signals of different wavelengths and is usually expressed by spectral response. FIG. 11 illustrates the efficiency of three different silicon-based sensors in receiving light signals and converting them into electrical signals at different wavelengths.

Once the type of the sensor is determined, the matching degree of the light source relative to the sensor can be evaluated based on a matching curve generated after superimposing the sensing spectral curve of the sensor and the emitting spectral curve. The matching curve generated after superimposing the sensing spectral curve and the emitting spectral curve is expressed by the following formula:

Z(λ)=W(λ)·S(λ); where λ is the wavelength, S(λ) is the sensing spectral curve, W(λ) is the emitting spectral curve, and Z(λ) is the matching curve.

It should be noted that, in this field, the value of the light source utilization rate (Z/W) is often used to compare how light sources from different light sources are utilized by the sensor. However, since the light source utilization rate cannot characterize the matching degree at each wavelength position, it is not suitable as a standard for measuring the light source matching degree. If the light source utilization rate is used as a standard for measuring the matching degree, the problem of non-uniform matching degree at each wavelength position is likely to occur, which will lead to a bias in the evaluation of the light source and increase the operating difficulty of the system.

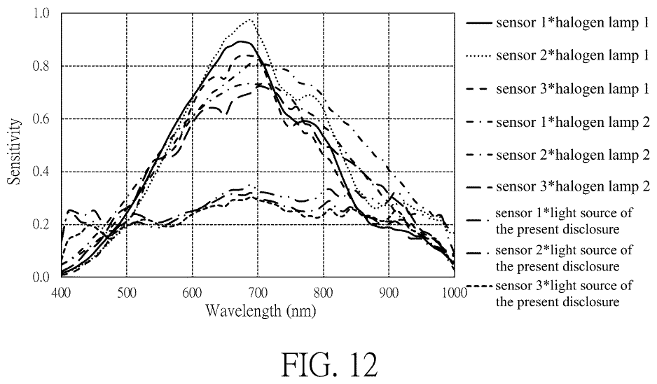

FIG. 12 is a graph of matching curves generated by superimposing the emitting spectral curves of FIG. 10 and the sensing spectral curves of FIG. 11. Based on the matching curve calculation method provided by the above-mentioned formula, the matching curves of the light source of the present disclosure and two types of halogen lamps relative to the three types of sensors of FIG. 11 are obtained as shown in FIG. 12. As can be seen from the curves in FIG. 12, the matching curves generated by the two types of halogen lamp light sources relative to the three types of sensors of FIG. 11 have a larger degree of fluctuation, and the matching degree at each wavelength is not uniform. In such a case, if the two types of halogen lamp light sources are used as the light sources for the three types of sensors of FIG. 11, the signal strength will be low and the imaging will be poor in spectral regions with low matching degrees, while signal saturation is likely to occur in spectral regions with high matching degrees. Accordingly, such an inconsistent matching degree will increase the difficulty of sensor adjustment, data processing, and spectrum analysis.

As shown in FIG. 12, it can be seen that the matching curve generated after superimposing the emitting spectral curve of the light source provided by the present disclosure and the sensing spectral curves of the three types of sensors in FIG. 11 has a smaller dispersion compared to the matching curves generated after superimposing the two types of halogen lamps and the sensing spectral curves of the three types of sensors. Accordingly, in practice, the sensing effect is more consistent in each range, which is beneficial for easing the adjustment difficulty of the sensor.

Furthermore, the calculated matching degree standard deviations of the various matching curves in FIG. 12 are as shown in Table 1 below:

TABLE 1

| | The light | | |
|---|---|---|---|
| | source | | |
| Matching degree | of the present | Halogen | Halogen |
| standard deviation | disclosure | lamp 1 | lamp 2 |
| Sensor 1 | 0.06 | 0.28 | 0.23 |
| Sensor 2 | 0.06 | 0.29 | 0.24 |
| Sensor 3 | 0.06 | 0.26 | 0.21 |

As can be seen from Table 1, the matching degree standard deviation of the matching curve of the light source provided by the present disclosure is less than 0.1, whereas the matching degree standard deviation of the two types of halogen lamps is within a range from 0.2 to 0.3. With a smaller standard deviation, the sensing effect of the sensor is more consistent in each range, which is more beneficial for subsequent data acquisition and processing.

### Beneficial Effects of the Embodiments

One of the beneficial effects of the present disclosure is that, in the light source, detection module, and method for generating the light source in the detection module provided by the present disclosure, the emitting spectral curve of the light source has a uniform and good matching degree with the sensing spectral curve of the sensor at each wavelength, and the standard deviation of the matching curve is less than 0.1, which, in practice, is more beneficial for easing the adjustment difficulty of the detection module.

Furthermore, in the light source, detection module, and method for generating the light source in the detection module provided by the present disclosure, the product of the sensing spectral curve and the emitting spectral curve obtained after a third-order polynomial regression at each wavelength and the dispersion degree of the matching curve after superimposing the sensing spectral curve and the emitting spectral curve are evaluated at the same time to optimize the overall spectral matching characteristics of the detection module and to ensure that the light source can provide a light signal that is most suitable for detection by the sensor.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for generating a light source in a detection module, comprising:
obtaining a sensor having a sensing spectral curve in a predetermined wavelength range; and
arranging a light source to generate a predetermined light having an emitting spectral curve in the predetermined wavelength range;
wherein, after the sensing spectral curve and the emitting spectral curve are overlapped with each other, a matching curve is generated and a standard deviation of the matching curve is less than 0.1; wherein the matching curve generated after the sensing spectral curve and the emitting spectral curve are overlapped is expressed by the following equation:
$$Z ( λ ) = W ( λ ) \cdot S ( λ ) ;$$
and
wherein λ is a wavelength, S(λ) is the sensing spectral curve, W(λ) is the emitting spectral curve, and Z(λ) is the matching curve.

2. The method according to claim 1, wherein the sensing spectral curve has a first regression curve after being subjected to a third-order polynomial regression, and a first coefficient of determination of the first regression curve is greater than or equal to 0.85; and wherein the emitting spectral curve has a second regression curve after being subjected to a third-order polynomial regression, and a second coefficient of determination of the second regression curve is greater than or equal to 0.85.

3. The method according to claim 2, wherein a product of the first regression curve and the second regression curve at a same wavelength is a constant.

4. The method according to claim 3, wherein the light source includes a plurality of light-emitting units, and the method further comprises:
sorting the light-emitting units according to corresponding bandwidths; and
starting with one of the light-emitting units having a widest bandwidth, determining a power proportion for each of the light-emitting units.

5. The method according to claim 4, wherein the light-emitting units includes:
at least one broadband visible light-emitting unit;
at least one narrowband visible light-emitting unit;
at least one broadband infrared light-emitting unit; and
at least one narrowband infrared light-emitting unit;
wherein, according to a power determination order, a process of determining the power proportion of each of the said light-emitting units, starting with one of the light-emitting units having a widest wavelength range, includes:
determining a power ratio between the at least one broadband visible light-emitting unit and the at least one broadband infrared light-emitting unit; and then determining a power of the at least one narrowband visible light-emitting units and a power of the at least one narrowband infrared light-emitting units;
wherein, when a plurality of the light-emitting units are of a same type, a total power is obtained by summing a plurality of power of the light-emitting units of the same type, and the power proportion for all of the light-emitting units is determined based on each of a plurality of total powers.

6. The method according to claim 1, wherein the predetermined light has the emitting spectral curve in a first wavelength range, the emitting spectral curve has a regression curve after being subjected to a third-order polynomial regression, and the regression curve has a minimum value in a second wavelength range; and
wherein the first wavelength range is from 400 nm to 1000 nm, the second wavelength range is from 540 nm to 560 nm, and a coefficient of determination of the regression curve is greater than or equal to 0.85.

7. A detection module, comprising:
a sensor, wherein the sensor has a sensing spectral curve within a predetermined wavelength range; and
a light source for generating a predetermined light, wherein the predetermined light has an emitting spectral curve within the predetermined wavelength range;
wherein, after the sensing spectral curve and the emitting spectral curve are overlapped with each other, a matching curve is generated and a standard deviation of the matching curve is less than 0.1; wherein the matching curve generated after the sensing spectral curve and the emitting spectral curve are overlapped is expressed by the following equation:
$$Z ( λ ) = W ( λ ) \cdot S ( λ ) ;$$
and
wherein λ is a wavelength, S(λ) is the sensing spectral curve, W(λ) is the emitting spectral curve, and Z(λ) is the matching curve.

8. The detection module according to claim 7, wherein the predetermined wavelength range is from 400 nm to 1000 nm.

9. The detection module according to claim 7, wherein the sensing spectral curve has a first regression curve after being subjected to a third-order polynomial regression, and a first coefficient of determination of the first regression curve is greater than or equal to 0.85; and wherein the emitting spectral curve has a second regression curve after being subjected to a third-order polynomial regression, and a second coefficient of determination of the second regression curve is greater than or equal to 0.85.

10. The detection module according to claim 7, wherein the light source includes a plurality of light-emitting units, and wherein the light-emitting units includes:
at least one broadband visible light-emitting unit;
at least one narrowband visible light-emitting unit;
at least one broadband infrared light-emitting unit; and
at least one narrowband infrared light-emitting unit.
